(19) United States
(12) Patent Application Publication
(10) Pub. No.: US 2011/0199993 A1
(43) Pub. Date: Aug. 18, 2011

(54) CHANNEL ASSIGNMENT METHOD, WIRELESS NETWORK APPARATUS AND CHANNEL ASSIGNMENT METHOD APPLIED IN WIRELESS NETWORK

(76) Inventors: Kuang-Yu Yen, Taichung City (TW); Jia-Ching Shen, Taipei City (TW); Chun-Wei Kuo, Tainan City (TW)

(21) Appl. No.: 13/025,170

(22) Filed: Feb. 11, 2011

(30) Foreign Application Priority Data
Feb. 12, 2010 (TW) 099104673

(51) Int. Cl. H04W 72/04

(52) U.S. Cl. 370/329

(57) ABSTRACT

A channel assignment method includes the following steps: settling a beginning time point and a terminating time point for communicating with a target client operated in an active mode; and performing a channel reservation mechanism for the target client at a first time point, wherein the first time point is earlier than the beginning time point.

### BACKGROUND OF THE INVENTION

1. Field of the Invention

The present invention relates to a wireless network system, and more particularly, to a channel assignment/reservation method of a wireless network system, and related apparatus.

2. Description of the Prior Art

In a wireless system network of client/server structure, clients can perform an optimization of power management according to a traffic characteristic therein. Real-time traffic includes certain characteristics: periodicity, delay sensitivity and error tolerance. Therefore, for power management of real-time traffic, the client assigns an accessible time point with an access point (AP) according to the traffic characteristic when a connection between the AP and the client is established. FIG. 1 is a timing diagram of an access point (also called a wireless base station) establishing a connection with a client to perform transmission according to the prior art. In the power management of general real-time traffic, when the AP establishes a connection with the client, the client will refer to the traffic characteristic thereof to assign an accessible time point to the AP. As shown in FIG. 1, the client will wake up periodically and enter an active mode to transmit/receive packets. When the sleep condition is met, the client goes enter a sleep mode, where the AP will not send packets to the client at this time until entering the active mode again. Many present structures and algorithms emphasize communication protocols between the client and the AP to avoid synchronization failure (e.g., missing information required for the protocol), and provide an accurate schedule for enhancing transmission success rates of specific traffic and a resource utilization efficiency of a wireless channel.

Since there are many interfering sources and multiple clients in a wireless environment, a wireless channel may be occupied at the accessible time point and therefore the client cannot start transmission at this time point, leading to a serious delay. Regarding the periodic traffic, a packet loss rate also rises and the duration in the active mode is also increased due to a serious delay. These above-mentioned problems will lead to an increment of average power consumption.

### SUMMARY OF THE INVENTION

One of objectives of the present invention is to provide a channel assignment method and related apparatus to solve the aforementioned problems.

According to one embodiment of the present invention, an exemplary channel assignment method is provided. The exemplary channel assignment method comprises: settling a beginning time point and a terminating time point for communicating with a target client operating in an active mode; and performing a channel reservation mechanism for the target client at a first time point, wherein the first time point is earlier than the beginning time point.

According to another embodiment of the present invention, an exemplary wireless network apparatus is provided for communicating with a plurality of clients. The exemplary wireless network apparatus comprises a processor and a storage unit. The storage unit stores a program code, wherein the processor performs the program code to execute the following steps: settling a beginning time point and a terminating time point for communicating with a target client operating in an active mode; and performing a channel reservation mechanism for the target client at a first time point, wherein the first time point is earlier than the beginning time point.

According to yet another embodiment of the present invention, an exemplary channel assignment method of a wireless network is provided. The exemplary channel assignment method comprises: settling a beginning time point for starting a transmission and a terminating time point for terminating the transmission with a target client of a plurality of clients, wherein the terminating time point is later than the beginning time point; and performing a channel reservation mechanism for the target client at a first time point, wherein the first time point is earlier than the beginning time point.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of an access point building up a connection with a client to perform transmission according to the prior art.

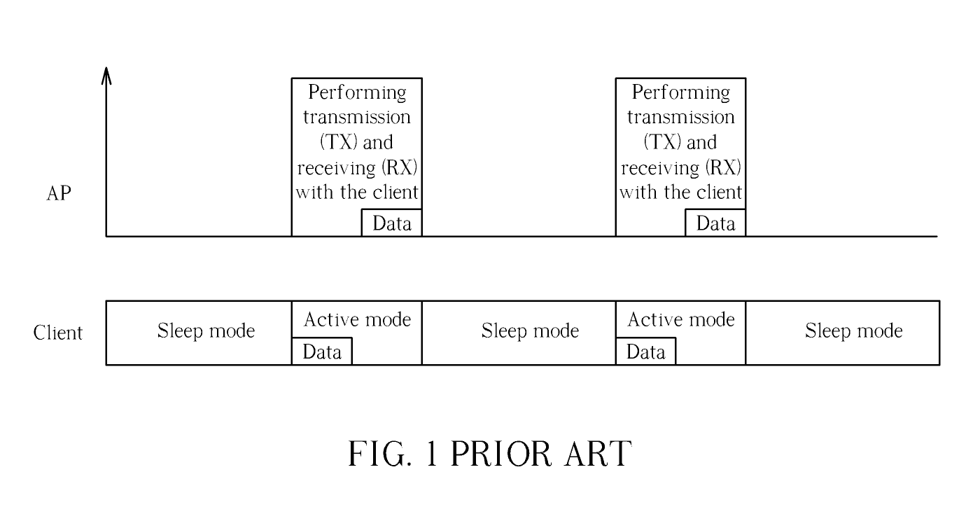

FIG. 2 is a diagram of a wireless network system according to an embodiment of the present invention.

FIG. 3 is a timing diagram of the wireless network system in FIG. 2 executing a radio frequency layer channel reservation mechanism according to an embodiment of the present invention.

FIG. 4 is a timing diagram of the wireless network system in FIG. 2 executing a media access control layer channel reservation mechanism according to an embodiment of the present invention.

FIG. 5 is a timing diagram of a first embodiment of a media access control layer channel reservation mechanism according to the present invention.

FIG. 6 is a timing diagram of a second embodiment of a media access control layer channel reservation mechanism according to the present invention.

FIG. 7 is a timing diagram of a third embodiment of a media access control layer channel reservation mechanism according to the present invention.

FIG. 8 is a timing diagram of a fourth embodiment of a media access control layer channel reservation mechanism according to the present invention.

FIG. 9 is a flowchart of the channel assignment method according to an embodiment of the present invention.

### DETAILED DESCRIPTION

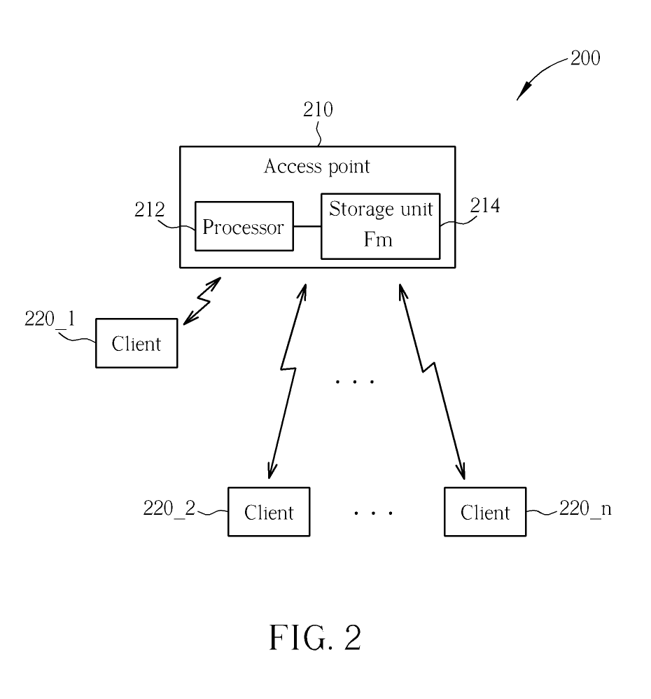

FIG. 2 is a diagram of a wireless network system according to an embodiment of the present invention. As shown in FIG. 2, the wireless network system 200 includes, but is not limited to, an access point (AP) 210 and a plurality of clients 200_1-200_n, wherein the access point 210 is arranged to communicate with clients 220_1-220_n. In this embodiment, the access point 210 includes, but is not limited to, a processor 212 and a storage unit 214, wherein the storage unit 214 stores a program code (for example, a firmware), and the processor 212 performs the program code to perform a channel reservation mechanism.

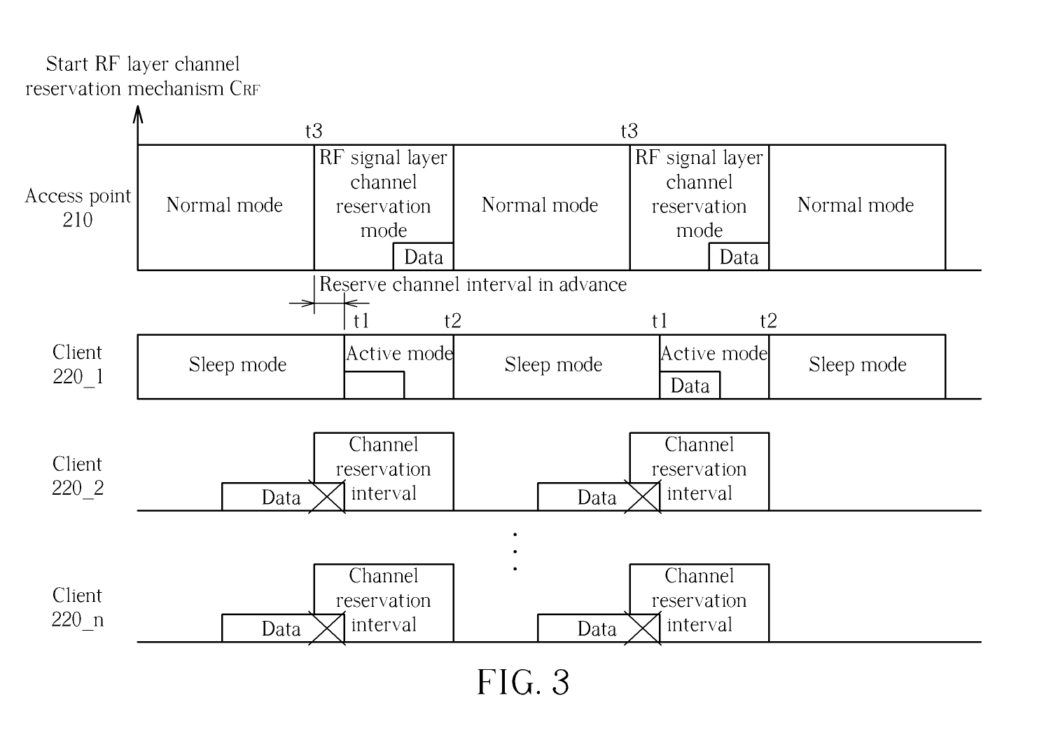

FIG. 3 is a timing diagram of the wireless network system 200 in FIG. 2 executing a radio frequency (RF) layer channel reservation mechanism C_{RF} according to an embodiment of the present invention. In this embodiment, a distance between the client 220_1 and the access point 210 is less than a distance between the client 220_2 and the access point 210; however, this is for illustrative purposes only and is not supposed to be a limitation of the present invention. As shown in FIG. 3, the client 220_1 and access point 210 settle a beginning time point t1 and a terminating time point t2. If another client 220_2 will perform data transmission before the time point t1, this client 220_2 may interfere with the communication between the client 220_1 and the AP 210 using the desired channel in an awaken interval (active mode, also called normal mode/operational mode). Therefore, in the channel reservation mechanism C_{RF}, the access point 210 reserves the desired channel in advance in a time point t3, and enters a channel reservation mode at the time point t3. In one embodiment of channel reservation mechanism, the access point 210 reduces a power of transmission signals to a lower or proper level in the channel layer reservation mode such that the transmission power is sufficient for the access point 210 to communicate with the client 220_1 but insufficient to communicate with the client 220_2, and therefore communication with the client 220_2 is terminated accordingly. In another embodiment, the access point 210 is enforced to break the communication with the client 220_2, leading to a termination with the client 220_2. Access point 210 closes the channel reservation mode at the time point t2. At the channel reservation interval, which indicates that the access point 210 starts a channel reservation mechanism for the client 220_1 and the access point 210 is in the channel reservation mode, the client 220_2 or other further clients cannot transmit normally. Therefore, the interference from other clients can be reduced, which ensures that there is a higher probability for the client 220_1 to acquire channel access and transmit successfully in the interval between t1 and t2.

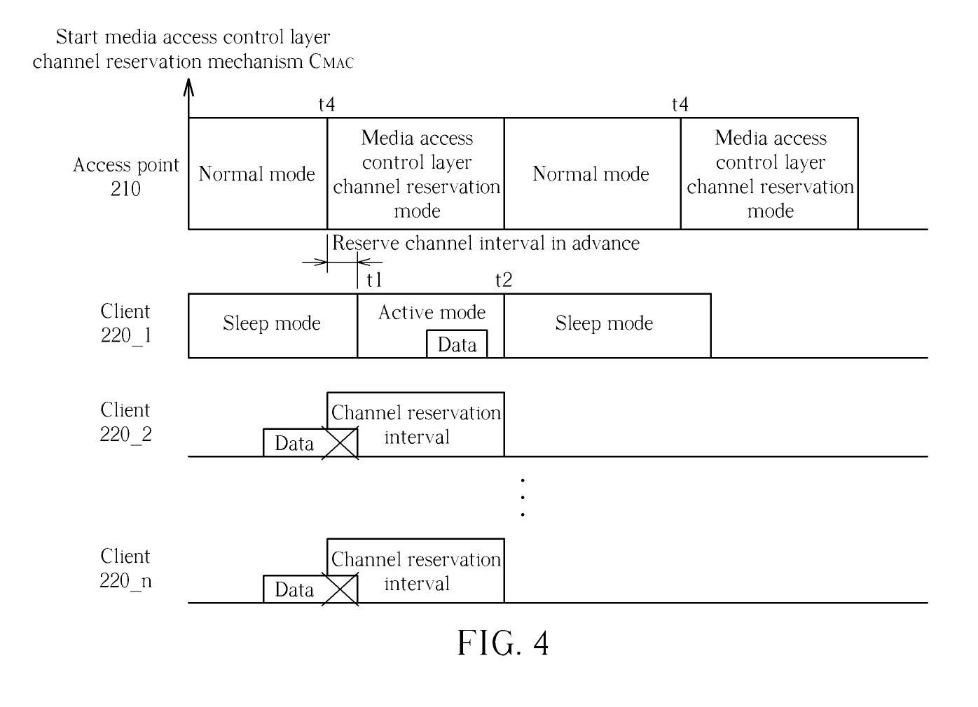

Please refer to FIG. 2 and FIG. 4 simultaneously. FIG. 4 is a timing diagram of the wireless network system 200 in FIG. 2 executing a media access control (MAC) layer channel reservation mechanism C_{MAC} according to an embodiment of the present invention. As shown in FIG. 4, the client 220_1 and the access point 210 settle a beginning time point t1 and a terminating time point t2. In the channel reservation mechanism C_{MAC}, the access point 210 reserves a channel in advance in a time point t4, and enters a MAC channel reservation mode at the time point t4. In the MAC channel reservation mode, the access point 210 performs a frame exchange sequence of channel reservation to ensure that a channel is reserved in the media access control layer for the client 220_1, which is about to start transmission, via net allocation vector (NAV) or other media access control layer mechanisms, and therefore the client 220_1 is ensured to acquire a channel access right and a successful transmission during an interval between the time points t1 and t2. The access point 210 closes the MAC channel reservation mode at the time point t2. The MAC channel reservation mechanism C_{MAC} is detailed in the following embodiment.

In the MAC channel reservation mode C_{MAC}, the access point 210 transmits a specific packet (e.g., a null data packet or a request to send (RTS) packet) to the clients 220_1-220_n, wherein the duration field of a header of the specific packet indicates a time interval from the time point t4 to the time point t2, and a designated receiving address in the specific packet is a MAC layer address of the client 220_1. When clients 220_2-220_n receive the specific packet, the duration time (i.e., t4-t2) in the specific packet is registered in the network allocation vectors of the clients 220_2-220_n, respectively. In this way, the client 220_1 can be ensured of acquiring a channel access right and a successful transmission in the time interval from time point t1 to time point t2.

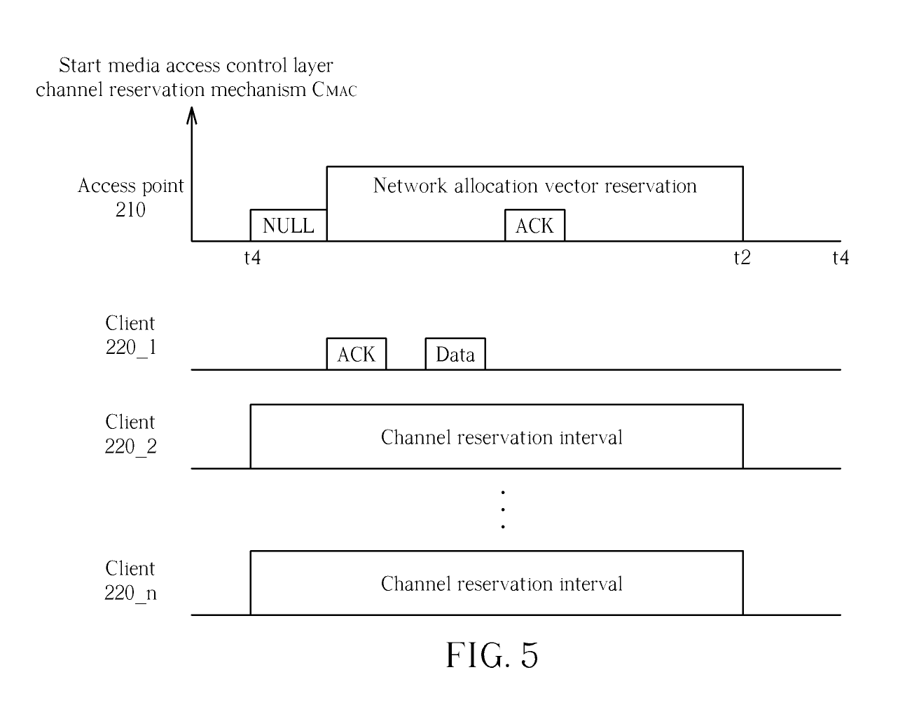

FIG. 5 is a timing diagram of a first embodiment of the MAC layer channel reservation mechanism C_{MAC} according to the present invention. As shown in FIG. 5, the specific packet can be a null data packet NULL.

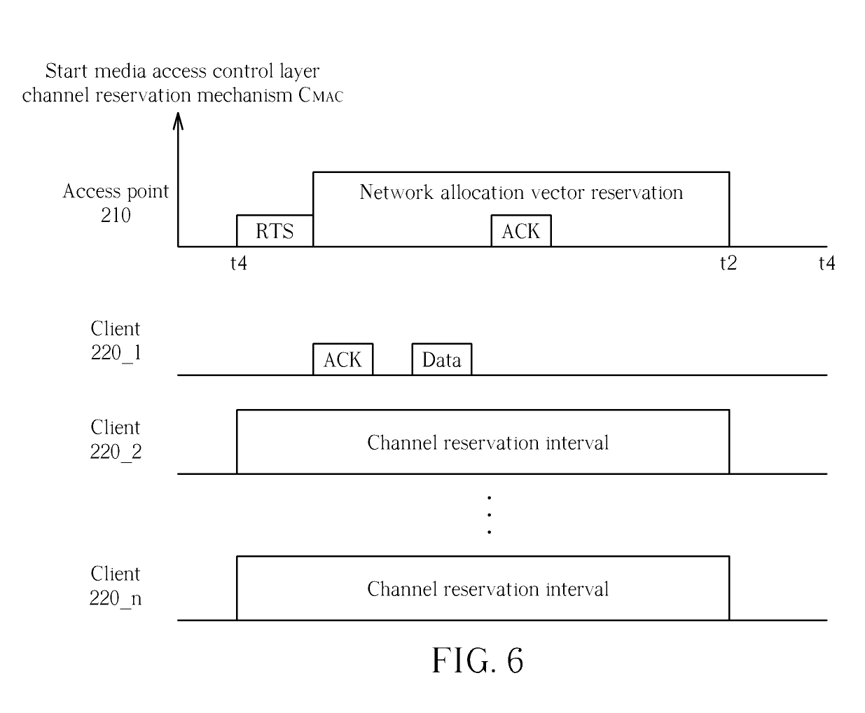

FIG. 6 is a timing diagram of a second embodiment of the MAC channel reservation mechanism C_{MAC} according to the present invention. As shown in FIG. 6, the specific packet is a request to send (RTS) packet RTS.

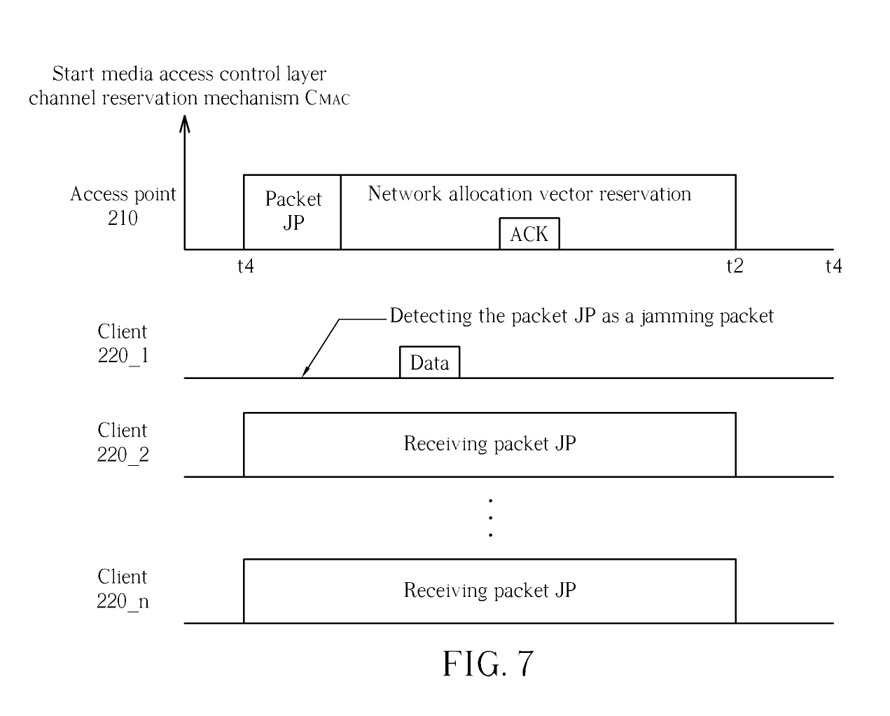

FIG. 7 is a timing diagram of a third embodiment of the MAC channel reservation mechanism C_{MAC} according to the present invention. In the MAC channel reservation mode, the access point 210 transmits a jamming packet JP to the clients 220_1-220_n, wherein a length field of a header of the packet JP guards a time interval from time point t4 to time point t2, and a designated receiving address of the jamming packet JP is a MAC address of the client 220_1. In the time interval from time point t4 to time point t2, the clients 220_2-220_n must receive a length indicated by the packetJP no matter whether the clients 220_2-220_n can identify the packet JP as a jamming packet or not, but the client 220_1 can identify the packet JP as a jamming packet. Since the indicated receiving address of the packet JP is the MAC address of the client 220_1, the access point 210 can perform normal transmission with the client 220_1 during the time interval from time point t4 to time point t2, whereas the clients 220_2-220_n will not try to transmit any packet. In this way, the client 220_1 can be ensured of acquiring a channel access right and a successful transmission during the time interval from time point t4 to time point t2.

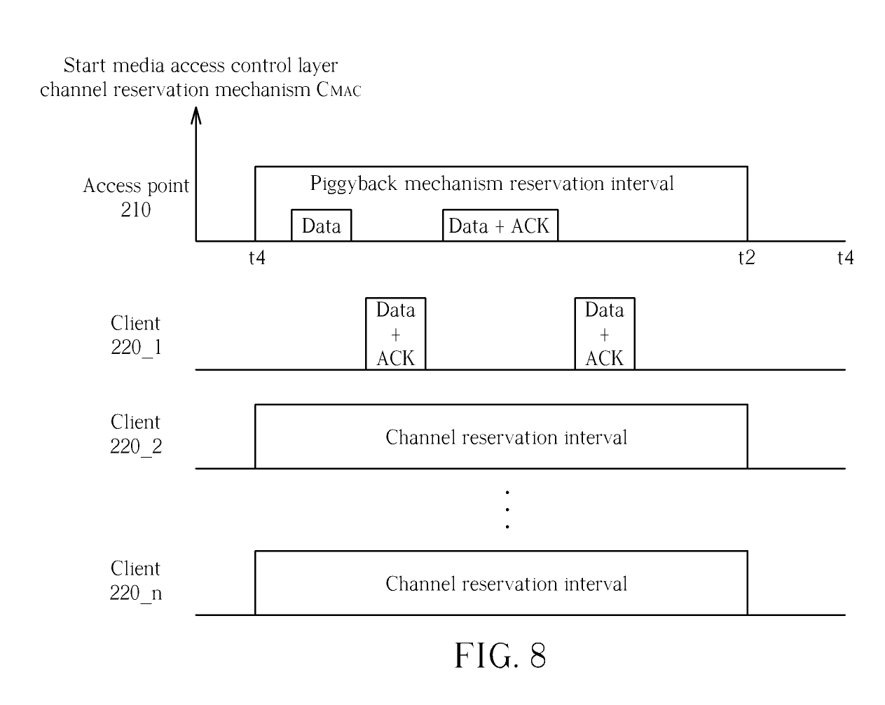

FIG. 8 is a timing diagram of a fourth embodiment of the MAC channel reservation mechanism C_{MAC} according to the present invention. The access point 210 utilizes a piggyback mechanism. In accordance with the piggyback mechanism, the access point 210 holds an access right of a channel CH1, therefore the clients have no access to the channel CH1 during the MAC layer channel reservation mode. The access point 210 transmits a first packet P1 to the client 220_1 via the channel CH1, and the client 220_1 can reply with an acknowledge (ACK) packet which also piggybacks at least one data. In this way, the client 220_1 can be ensured of having a channel access and a successful transmission during the time interval from time point t4 to time point t2.

Please note that the aforementioned embodiments are for illustrative purposes only, and are not supposed to be taken as limitations to the present invention. For example, the aforementioned two mechanisms can be utilized simultaneously or independently, depending upon different operational conditions.

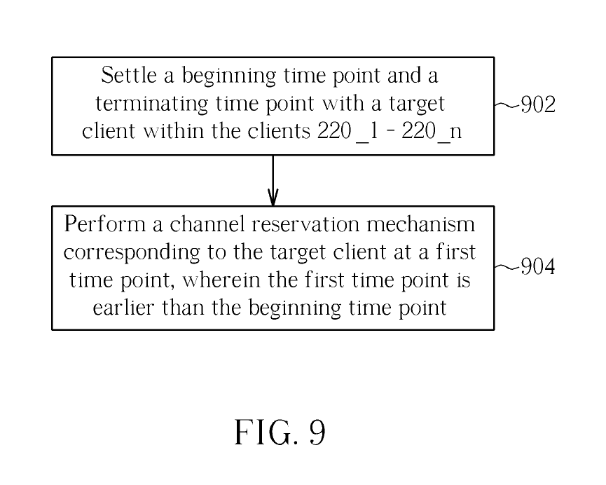

Please refer to FIG. 9, which is a flowchart of a channel reservation method according to an embodiment of the present invention. If the result is substantially the same, the steps are not required to be executed in the exact order shown in FIG. 9. In addition, the steps in FIG. 9 are not required to be executed sequentially, i.e., other steps can be inserted in between. The steps of the exemplary channel assignment method are summarized as follows:

Step 902: Settle a beginning time point and a terminating time point with a target client (e.g., the client 220_1) within the clients 220_1-220_n.

Step 904: Perform a channel reservation mechanism corresponding to the target client (e.g., the client 220_1) at a first time point, wherein the first time point is earlier than the beginning time point.

In the embodiments according to the present invention, the transmission between the target client and the AP can be assured to have the higher priority and transmitting/receiving probability, leading to an optimized packet loss rate, delay characteristic and average power consumption in a real-time communication.

Those skilled in the art will readily observe that numerous modifications and alterations of the device and method may be made while retaining the teachings of the invention.

What is claimed is:

1. A channel assignment method in a wireless network, comprising:
settling a beginning time point and a terminating time point for communicating with a target client operated in an active mode; and
performing a channel reservation mechanism for the target client at a first time point, wherein the first time point is earlier than the beginning time point.

2. The channel assignment method of claim 1, wherein the step of performing the channel reservation mechanism comprises:
reducing a transmission power to a level which is still capable of allowing a successful communication with the target client.

3. The channel assignment method of claim 1, wherein the step of performing the channel reservation mechanism comprises:
terminating a transmission with other client which is not the target client.

4. The channel assignment method of claim 1, wherein the step of performing the channel reservation mechanism comprises:
performing a frame exchange sequence to achieve channel reservation.

5. The channel assignment method of claim 4, wherein the frame exchange sequence comprises:
transmitting a specific packet to at least one client, wherein a first field of a header of the specific packet comprises information of the first time point, and an address of the specific packet comprises an address of the target client.

6. The channel assignment method of claim 5, wherein the specific packet is one of following packets: a null data packet, a request to sent (RTS) packet and a jamming packet.

7. The channel assignment method of claim 4, wherein the frame exchange sequence comprises:
acquiring an access right of a channel and transmitting a packet to the target client via the channel; and
the target client replying with an acknowledge (ACK) packet which piggybacks at least a data.

8. The channel assignment method of claim 4, wherein the target client is in a sleep mode at the first time point.

9. A wireless network apparatus, for communicating with a plurality of clients, the wireless network apparatus comprising:
a processor; and
a storage unit, coupled to the processor, to store a program code,
wherein the processor executes the program code to
settle a beginning time point and a terminating time point for communicating with a target client operated in an active mode; and
perform a channel reservation mechanism for the target client at a first time point, wherein the first time point is earlier than the beginning time point.

10. The wireless network apparatus of claim 9, wherein in the channel reservation mechanism, a transmission power of the wireless network apparatus is reduced to a level which is still capable of allowing a successful communication with the target client.

11. The wireless network apparatus of claim 9, wherein in the channel reservation mechanism,
a transmission with other client is terminated.

12. The wireless network apparatus of claim 9, wherein the channel reservation mechanism comprises:
performing a frame exchange sequence to achieve channel reservation.

13. The wireless network apparatus of claim 12, wherein the step of performing the frame exchange sequence comprises:
transmitting a specific packet to a plurality of clients, wherein a first field of a header of the specific packet comprises data of the first time point, and an address of the specific packet comprises an address of the target client.

14. The wireless network apparatus of claim 13, wherein the specific packet is one of following packets: a null data packet, a request to sent (RTS) packet and a jamming packet.

15. The wireless network apparatus of claim 12, wherein the processor performs the program code to acquire an access right of a channel and transmit a packet to the target client via the channel, and the target client replies with an acknowledge (ACK) packet which piggybacks at least a data.

16. The wireless network apparatus of claim 12, wherein the target client is in a sleep mode at the first time point.

17. A channel assignment method applied in a wireless network, comprising:
settling a beginning time point for starting a transmission and a terminating time point for terminating the transmission with a target client of a plurality of clients, wherein the terminating time point is later than the beginning time point; and
performing a channel reservation mechanism for the target client at a first time point, wherein the first time point is earlier than the beginning time point.
